(19) United States
(12) Patent Application Publication
(10) Pub. No.: US 2013/0051292 A1
(43) Pub. Date: Feb. 28, 2013

(54) COMMUNICATION APPARATUS AND METHOD USING PSEUDO-RANDOM CODE

(71) Applicants: Hyun-kuk Choi, Suwon-si (KR); Sang-Yun Hwang, Suwon-si (KR); Jong-Rim Lee, Yongin-si (KR); Ki-Uk Kim, Suwon-si (KR); Ji-Hye Hur, Suwon-si (KR); Chul-Jin Kim, Yongin-si (KR)

(72) Inventors: Hyun-kuk Choi, Suwon-si (KR); Sang-Yun Hwang, Suwon-si (KR); Jong-Rim Lee, Yongin-si (KR); Ki-Uk Kim, Suwon-si (KR); Ji-Hye Hur, Suwon-si (KR); Chul-Jin Kim, Yongin-si (KR)

(21) Appl. No.: 13/696,740

(22) PCT Filed: May 7, 2010
(86) PCT No.: PCT/KR10/02934

§ 371 Date: Nov. 7, 2012

(51) Int. Cl. H04J 13/10; H04B 7/24

(52) U.S. Cl. 370/310; 370/479

(57) ABSTRACT

According to the present invention, a communication apparatus comprises: a preamble generator which generates a pseudo-random code; a band shaping code generator which generates a band shaping code having a higher frequency than the pseudo-random code; a calculator which performs a calculation of the pseudo-random code and the band shaping code and outputs a preamble obtained through the calculation; and a multiplexer which multiplexes the preamble for synchronization with a second communication apparatus, a header, and data, and outputs a data frame obtained through the multiplexing.

### TECHNICAL FIELD

The present invention relates to a frame communication apparatus and method for transmitting or receiving a data frame, and more particularly, to a communication apparatus and method through a data frame including a preamble for signal synchronization.

### BACKGROUND ART

An electric field communication refers to a communication method in which data can be transmitted and received by inducing an electric field by a transmission terminal to form the electric field through a dielectric material and then by sensing the electric field at a receiver terminal. Among these electrical communications, a communication method in which a human body is considered as a dielectric material is called a human body communication. In other words, the “human body communication” is a technology of communicating between communication apparatuses connected with the human body as a communication medium, i.e., a technology of transmitting data by communication apparatus on a transmission side, which is attached to a part of the human body, through an electrode and receiving the data by a communication apparatus on a receiver side, which is attached to other side of the human body, through the electrode.

The data frame used in the human body communication generally has a frequency band of tens of MHz.

FIG. 1 is a view illustrating a noise versus frequency characteristic of a human body in a base band (˜100 MHz) and FIG. 2 is a view illustrating a noise versus frequency characteristic in a base band in a laboratory environment. The human body communication has a high noise from the human body in a band of several MHz and is characterized in that the noise is spread across a band of tens of MHz. Therefore, in the human body communication, data is modulated to be transmitted such that a band of the transmission data is not in the band of several MHz in which a human body noise is concentrated.

A channel in the base band is affected by an interruption by a passive radio-frequency identification (RFID) reader which covers from a band of 13.56 MHz to a carrier power of a tag, a clock noise of a communication board, and attenuation per frequency of a dielectric material used as a medium. In addition, most oscillator clocks use a few MHz to tens of MHz such that a receiver of a base band communication method has a problem of degradation in receiver sensitivity. In a case where communication is performed using the dielectric material as the medium, when a transmission frequency is high, signal transmission through radiation is stronger than signal transmission through the dielectric material.

A communication apparatus used in the human body communication includes a transmission unit and a receiving unit, and performs communication by using a data frame. For transmission and reception of the data frame between two communication apparatuses, inter-synchronization is needed, and for synchronization, the communication apparatus on the transmission side transmits the synchronization signal for indicating a start of the data frame. The communication apparatus on the receiver side which receives the data frame identifies the synchronization signal to obtain a frame timing and processes the received data frame according to the obtained frame timing.

It is common to use a preamble sequence for the synchronization signal. If the preamble is not accurately received, data transmitted subsequently to the preamble may not be received or a wrong data may be received.

### DETAILED DESCRIPTION OF THE INVENTION

### Technical Problem

Therefore, there has been a necessity for a communication apparatus and method for generating a preamble capable of improving receiving sensitivity by controlling a center frequency and a bandwidth of a data frame in a communication field having a poor noise-related communication environment.

### Technical Solution

In accordance with an aspect of the present invention, there is provided a communication apparatus using a pseudo random code including: a preamble generator for generating a pseudo random code; a band shaping code generator for generating a band shaping code having a frequency higher than that of the pseudo random code; an operator for outputting a preamble obtained by operating the pseudo random code and the band shaping code; and a multiplexer for outputting a data frame obtained by multiplexing the preamble for synchronizing with a second communication apparatus, a header, and a data.

In accordance with another aspect of the present invention, there is provided a communication apparatus using a pseudo random code including: a transmission unit for generating a first data frame including a preamble for synchronizing with a second communication apparatus, a header, and a data; a receiving unit for receiving a second data frame from the second communication apparatus; and a controller for outputting information comprising the first data frame to the transmission unit and receiving information included in the second data frame from the receiving unit, wherein the transmission unit generates the pseudo random code and a band shaping code having a frequency higher than that of the pseudo random code and generates the preamble through an operation of the pseudo random code and the band shaping code.

In accordance with another aspect of the present invention, there is provided a communication method using a pseudo random code including: generating the pseudo random code; generating a band shaping code having a frequency higher than that of the pseudo random code; outputting a preamble obtained by operating the pseudo random code and the band shaping code; and outputting a data frame obtained by multiplexing the preamble for synchronizing with a second wireless communication apparatus, a header and a data.

### Advantageous Effects

A communication apparatus and method using a pseudo random code according to the present invention has advantages in that a receiving characteristic may be improved compared to the prior art even with a poor signal to noise ratio by using a preamble generated through an operation of the pseudo random code and a band shaping code.

A communication apparatus and method using a pseudo random code according to the present invention has advantages in that a center frequency and a bandwidth of a data frame for communication may be easily adjusted by controlling a frequency of a band shaping code.

### BRIEF DESCRIPTION OF THE DRAWINGS

FIG. 1 is a view illustrating a noise versus frequency characteristic of a human body in a base band;

FIG. 2 is a view illustrating a noise versus frequency characteristic in a base band in a laboratory environment;

FIG. 3 is a view illustrating a structure of a data frame according to an exemplary embodiment of the present invention;

FIG. 4 is a view illustrating a communication apparatus according to an exemplary embodiment of the present invention;

FIG. 5 is a view illustrating a structure of a band shaping unit provided in a band shaper shown in FIG. 4;

FIG. 6 is a view illustrating a frequency characteristic of a preamble output from a band shaping unit;

FIG. 7 is a view illustrating a curve of a correlation value over time with respect to a preamble sequence which is repeated four times;

FIG. 8 is a view for explaining a process of determining by a preamble processor whether a preamble is normally received; and

FIG. 9 is a view for explaining a receiving characteristic of a communication apparatus according to the present invention.

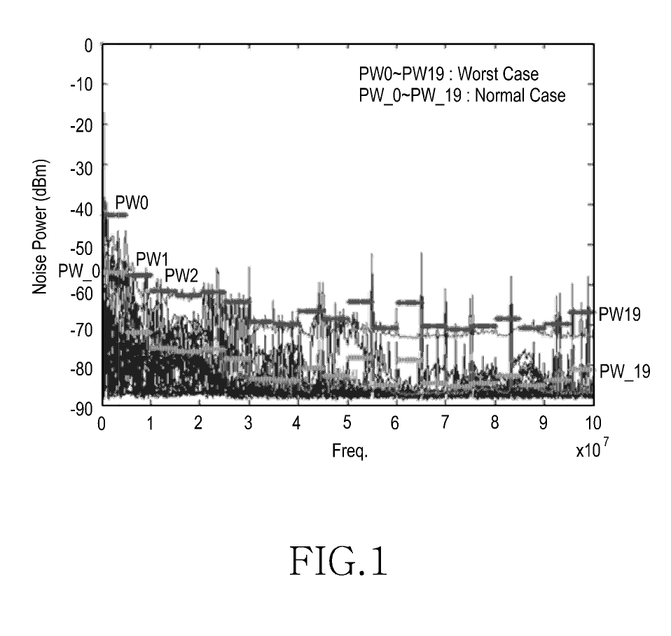

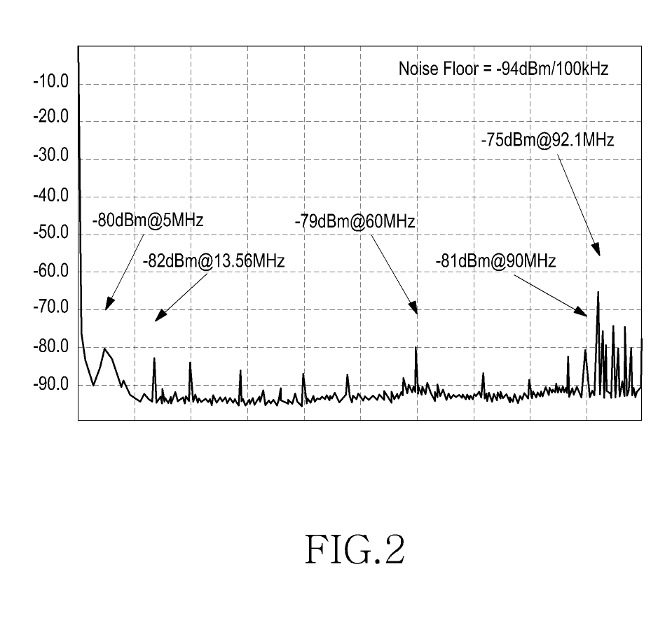

### MODE FOR CARRYING OUT THE INVENTION

Exemplary embodiments of the present invention will be described herein below with reference to the accompanying drawings. In the following description, well-known functions or constructions are not described in detail to avoid obscuring the subject matter of the present invention.

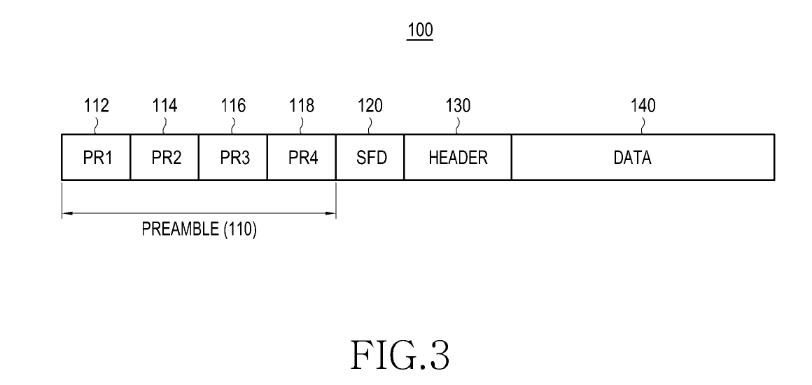

FIG. 3 is a view illustrating a structure of a data frame according to an exemplary embodiment of the present invention. A data frame 100 includes a preamble 110 for notifying another communication apparatus (hereinafter, “second communication apparatus”) of a start of the data frame 100 and, at the same time, synchronizing with the second wireless communication apparatus, a start frame delimiter (SFD) 120 for notifying a start location of a header 130, the header 130 having information of a source and a destination addresses, and data 140 having information of actual transmission (or user) data such as a voice, an image, a text, or a message.

The preamble 110 comprises four consecutive preamble units 112-118 having the same length and information.

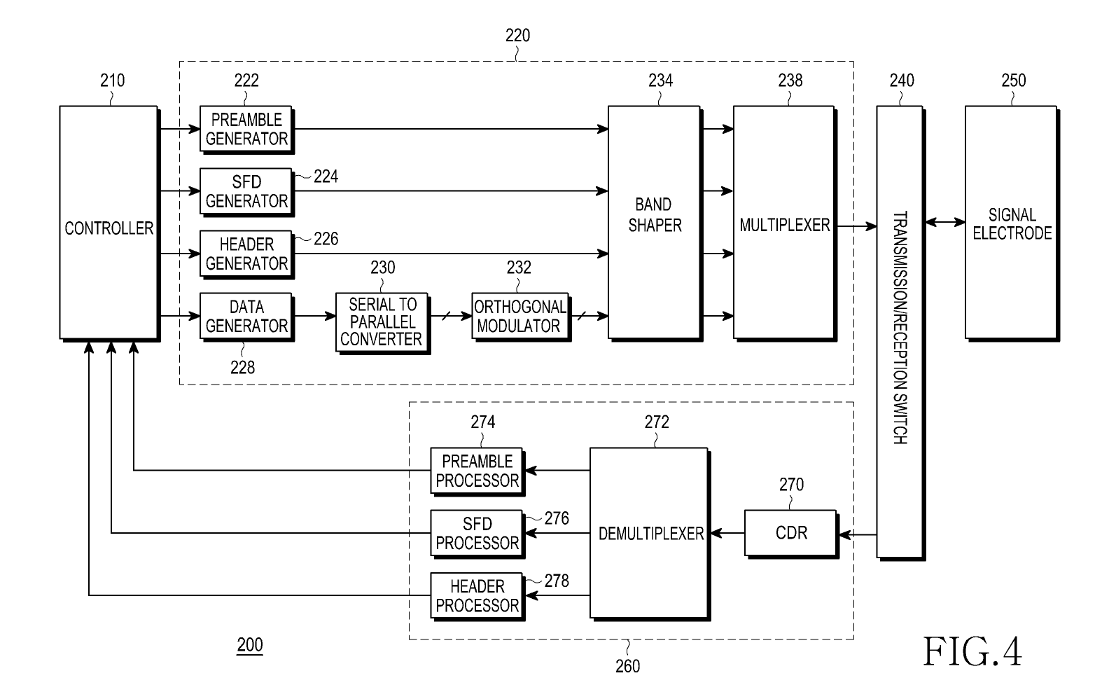

FIG. 4 is a view illustrating a communication apparatus according to an exemplary embodiment of the present invention. The communication apparatus 200 includes a transmission unit 220 for generating a first data frame including a preamble for synchronizing with another communication apparatus (hereinafter, “second communication apparatus”), an SFD, a header, and a data, a receiving unit 260 for receiving a second data frame from the second wireless communication apparatus, a controller 210 for outputting information which constructs the first data frame to the transmission unit 220 and receiving information included in the second data frame from the receiving unit 260, a transmission/reception switch 240 for outputting the first data frame from the transmission unit 220 to a signal electrode 250 and outputting the second data frame from the signal electrode 250 to the receiving unit 260, and the signal electrode 250 for transmitting the first data frame from the transmission/reception switch 240 to a dielectric medium and outputting the second data frame from the dielectric medium to the transmission/reception switch 240.

The transmission unit 220 includes a preamble generator 222, an SFD generator 224, a header generator 226, a data generator 228, a serial to parallel converter 230, an orthogonal modulator 232, a band shaper 234, and a multiplexer 238. The preamble generator 222 generates a preamble having a good auto-correlation characteristic according to control of the controller 210 to be output to the band shaper 234. For the preamble, a pseudo-random code such as a gold code or a Kasami code having the good auto-correlation characteristic which is well known to a person of ordinary skill in the art may be used. For example, the gold code is described in detail in S. Sarwate, M. Pursley, “Crosscorrelation properties of pseudorandom and related sequences”, IEEE Proceedings, Vol. 68, May 1980. In this embodiment, the gold code which is a kind of the pseudo random code is used for the preamble. Hereinafter, for illustrative purposes, the preamble output from the preamble generator is referred to as the pseudo random code. The SFD generator 224 generates the SFD for notifying the start location of the header according to the control of the controller 210 to be output to the band shaper 234, and the header generator 226 generates the header having information such as the source address and the destination address according to the control of the controller 210 to be output to the band shaper 234.

The data generator 228 generates data having user data information according to the control of the controller 210 to be output to the serial to parallel converter 230.

The serial to parallel converter 230 converts a serial data input to the data generator 228 to a parallel data to form a symbol. For example, when a transmission rate of the data is C and a 1:P serial-to-parallel converter is used, the serial data is converted into a P-bit symbol and the converted symbol has 2^{P} number of kinds.

The orthogonal modulator 232 maps the symbol input from the serial-to-parallel converter 230 to one of sequences having orthogonal modulation, i.e., inter orthogonal characteristic to be output. For example, the orthogonal converter has sequences having a length of 2^{Q2} and maps the symbol to one of 2^{P} sequences according to P-bit information of the symbol. A transmission rate of data output from the orthogonal modulator becomes (C·2^{Q2})/P. The orthogonal modulator 232 can be referred to as a symbol code mapper.

The band shaper 234 includes four band shaping units which have a one-to-one correspondence with the preamble generator 222, the SFD generator 224, the header generator 226, and the data generator 228 (or the orthogonal modulator 232) and have the same structure as one another, and adjusts respective bandwidths and center frequencies of the pseudo random code, the SFD, the header, and the data input from the above elements to be output.

The four band shaping units have the same configuration, and therefore, only the band shaping unit corresponding to the preamble generator 222 will be described in detail hereinafter.

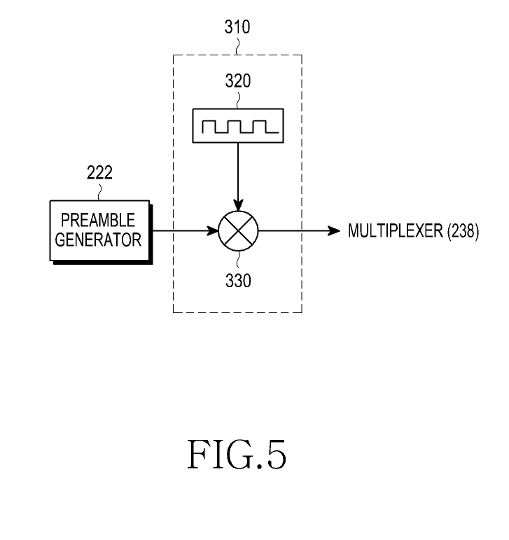

FIG. 5 is a view illustrating a structure of a band shaping unit 310 provided in the band shaper 234 and corresponding to the preamble generator 222. The band shaping unit 310 includes a band shaping code generator 320 and a multiplier 330.

The band shaping code generator 320 generates a band shaping code having a higher frequency than the pseudo random code input from the preamble generator 222 and having the same pattern as a clock signal. Namely, the band shaping code generator 320 generates a code in which 1 bit (or 1 level bit) and 0 bit (or −1 level bit) are repeated. Preferably, the frequency of the band shaping code is n times of a frequency of the pseudo random code, and n is an integer. More preferably, the frequency of the band shaping code is four times of the frequency of the pseudo random code.

The multiplier 330 performs a multiplication operation of the pseudo random code and the band shaping code to be output. For example, if the length of the pseudo random code is M bits per unit time and the length of the band shaping code is L (2^{N}) bits per unit time, the length of the preamble output from the multiplier 330 is M×L bits per unit time.

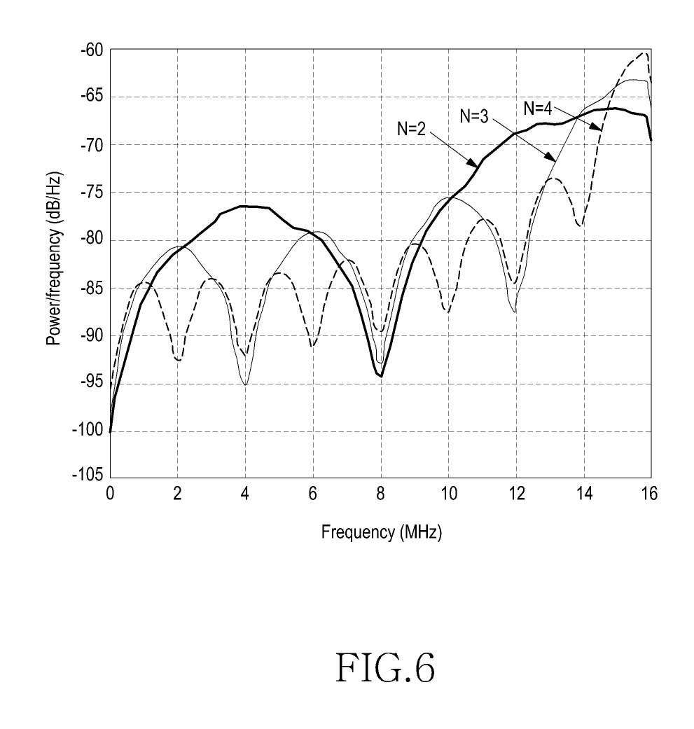

FIG. 6 is a view illustrating a frequency characteristic of a preamble output from the band shaping unit 310. By adjusting a factor N of the length of the band shaping code, the bandwidth of the preamble may be adjusted. Also, the center frequency of the preamble output from the band shaping unit 310 is the same as the frequency of the band shaping code. Specifically, for example, when the frequency of the pseudo random code is 8 Mcps and the bits per unit time of the shaping code is 4, the frequency of the band shaping code becomes 32 Mcps (=8 Mcps×L=8 Mcps×4) and the center frequency of the preamble output from the band shaping unit 310 becomes 16 MHz corresponding to 32 Mcps. Put in another way, when the pseudo random code has 128 bits, the preamble output from the band shaping unit 310 becomes 512 bits.

In other words, according to the above described operation of the band shaper 234, an overall center frequency and a bandwidth of the first data frame may be controlled. When a value of N increases, the bandwidth decreases while, at the same time, the auto-correlation characteristic is degraded, and therefore, the value of N needs to be set by considering conditions, and preferably has a value in a range of 1 to 3.

The multiplexer 238 generates the first data frame by multiplexing the preamble, the SFD, the header, and the data input from the band shaper 234 to be output to the transmission/reception switch 240.

The transmission/reception switch 240 outputs the first data frame from the multiplexer 238 to the signal electrode 250 and outputs the second data frame from the signal electrode 250 to the receiving unit 260. The signal electrode 250 transmits the first data frame from the transmission/reception switch 240 to the dielectric medium, and outputs the second data frame from the dielectric medium to the transmission/reception switch 240. The receiving unit 260 includes an analog front end (AFE) 270, a demultiplexer 272, a preamble processor 278, a header processor 274, a data demodulator 276, and an SFD processor 277.

The AFE 270 amplifies the received second data frame and performs a 1 bit decision such that the second data frame is separated into the preamble, the SFD, the header, and the data through the demultiplexer 272 to be output.

The preamble processor 278 determines whether the preamble is normally received.

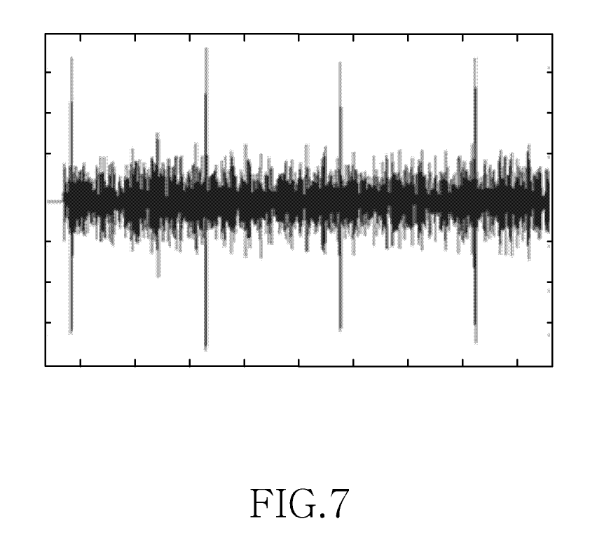

FIG. 7 is a view illustrating a curve of a correlation value over time with respect to a preamble sequence which is repeated four times, i.e., a preamble having the same four preamble units. As illustrated, the preamble unit (or the preamble sequence) is repeated four times, and accordingly, four peak values of the correlation value are obtained.

The peak value of the correlation value is obtained by the preamble processor 278 by the following Equation 1.

peak={arg max(x(N))>PREAMBLE_{—}TH_VALUE} [Equation ]

In the Equation 1, peak represents the peak value of the correlation value, x(N) represents a sampling correlation value of N-th degree, PREAMBLE_TH_VALUE represents a threshold correlation value for determining the peak value.

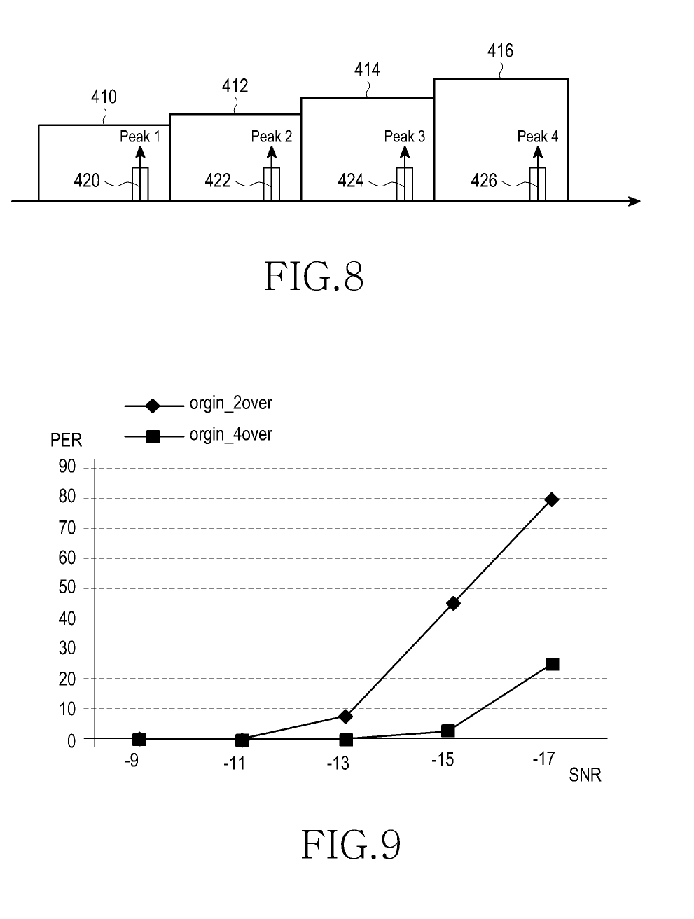

FIG. 8 is a view for explaining a process of determining by the preamble processor 278 whether the preamble is normally received. In FIG. 8, four preamble unit intervals 410-416 and peaks 420-426 of the correlation values for respective intervals 410-416 are shown. Peaks 1-4 indicate a distance from an arbitrary location (for example, the start location of the preamble) to a corresponding peak 420-426 of the correlation value.

The SFD processor 277 extracts and outputs SFD information from the SFD input from the demultiplexer 272 to the controller 210.

The preamble processor 278 calculates an interval error between the peaks 420-426 of the correlation values, which are expressed as the following Equation 2.

PI₃=Peak4−(Peak3+PrN)

PI₂=Peak3−(Peak2+PrN)

PI₁=Peak2−(Peak1+PrN) [Equation 2]

In the above equation, PI_{1˜3} represent interval errors of corresponding correlation peaks, PrN represents a length of an interval of the preamble unit. For example, PI₁ represents a difference between an interval between the first correlation peak 420 and the second correlation peak 422 and the length of the interval of the preamble unit.

The preamble processor 278 determines whether the interval errors of corresponding peaks 420-426 of the correlation values are within a permissible level, which is expressed as the following Equation 3.

condition1:|PIₙ|<PREAMBLE_{—}K_VALUE and |PIₙ₊₁|<PREAMBLE_{—}K_VALUE

condition2:|PIₙ|<PREAMBLE_{—}K_VALUE or |PIₙ₊₁|<PREAMBLE_{—}K_VALUE

In the above equation, PREAMBLE_K_VALUE represents a permissive level of the interval errors of the peak values of the correlation values 420-426, and for example, the permissive level may be set as zero.

The preamble processor 278 outputs synchronization information to the controller 210 when the preamble is normally received, and the controller 210 performs frame synchronization according to the received synchronization information from the preamble processor 278 and controls the demultiplexer 272 to normally separate the header and the data according to the synchronization information and the SFD information.

The header processor 274 extracts header information from the header input from the demultiplexer 272 to be output to the controller 210.

The data demodulator 276 extracts data information from the data input from the demultiplexer 272 to be output to the controller 210. To this end, the data demodulator 276 may perform a process of orthogonal demodulation or parallel-to-serial conversion.

FIG. 9 is a view for explaining a receiving characteristic of the communication apparatus 200 according to the present invention. FIG. 9 shows a receiving characteristic in case of receiving the preamble sequence which is repeated four times by using a 128 bit gold code and four bit band shaping code (i.e., comprising four preamble units). Also, FIG. 9 show a signal to noise ratio (SNR) curve measured by oversampling twice a signal sampled by the preamble processor 278 and an SNR curve measured by oversampling four times the sampled signal.

As illustrated, by using the preamble generated through an operation of the pseudo random code and the band shaping code, the receiving characteristic may be improved compared to the prior art even with a poor signal to noise ratio.

Meanwhile, while the present invention has been described with connection to exemplary embodiments, a person skilled in the art should understand that the present invention can be embodied in other specific forms without departing from the technical spirit or essential characteristics thereof.

It should be noted that a communication method using a pseudo random code may be implemented by hardware, software (i.e., program), or any combination thereof The program may be stored in a volatile or non-volatile recording medium readable by a machine such as a computer, and the recording medium may be a storage apparatus such a Read-Only Memory (ROM), a memory such as a Random Access Memory (RAM), a memory chip, or an integrated circuit, and an optical or magnetic recording medium such as a compact disk (CD), a DVD, a magnetic disk, or a magnetic tape. In other words, the communication method using the pseudo random code of the present invention may be implemented in a program including codes. Further, such a program may be electrically transmitted through any medium similar to a communication signal which is propagated by wire or wirelessly, and the present invention includes equivalents thereof.

1. A communication apparatus using a pseudo random code, comprising:
a preamble generator for generating a pseudo random code;
a band shaping code generator for generating a band shaping code having a frequency higher than that of the pseudo random code;
an operator for outputting a preamble obtained by operating the pseudo random code and the band shaping code; and
a multiplexer for outputting a data frame obtained by multiplexing the preamble for synchronizing with a second communication apparatus, a header, and data.

2. The communication apparatus using the pseudo random code of claim 1, wherein the pseudo random code is a gold code.

3. The communication apparatus using the pseudo random code of claim 1, wherein, in the band shaping code, 0 bit and 1 bit are repeated.

4. The communication apparatus using the pseudo random code of claim 1, wherein a frequency of the band shaping code is n times a frequency of the pseudo random code, and n is an integer.

5. A communication apparatus using a pseudo random code, comprising:
a transmission unit for generating a first data frame including a preamble for synchronizing with a second communication apparatus, a header, and data;
a receiving unit for receiving a second data frame from the second communication apparatus; and
a controller for outputting information comprising the first data frame to the transmission unit and receiving information included in the second data frame from the receiving unit, wherein the transmission unit generates the pseudo random code and a band shaping code having a frequency higher than that of the pseudo random code and generates the preamble through an operation of the pseudo random code and the band shaping code.

6. The communication apparatus using the pseudo random code of claim 5, wherein the transmission unit comprises:
a preamble generator for generating the pseudo random code;
a band shaper for generating the band shaping code having the frequency higher than that of the pseudo random code and operating the band shaping code and each of the pseudo random code, the header and the data; and
a multiplexer for outputting the first data frame obtained by multiplexing the operated pseudo random code being the preamble, the operated header, and the operated data.

7. The communication apparatus using the pseudo random code of claim 5, wherein the receiving unit comprises:
a demultiplexer for separating and outputting the second data frame into the preamble, the header, and the data;
a preamble processor for obtaining synchronization information from correlation peak values of the separated preamble; and
a controller for controlling the demultiplexer to separate the header and the data according to the synchronization information obtained by the preamble processor.

8. The communication apparatus using the pseudo random code of claim 6, wherein the pseudo random code is a gold code and, in the band shaping code, 0 bit and 1 bit are repeated.

9. The communication apparatus using the pseudo random code of claim 8, wherein the frequency of the band shaping code is four times a frequency of the pseudo random code.

10. A communication method using a pseudo random code, comprising:
generating the pseudo random code;
generating a band shaping code having a frequency higher than that of the pseudo random code;
outputting a preamble obtained by operating the pseudo random code and the band shaping code; and
outputting a data frame obtained by multiplexing the preamble for synchronizing with a second wireless communication apparatus, a header and a data.

11. A computer-readable recording medium having recorded thereon a program for executing the communication method using the pseudo random code of claim 10.
